(19) United States
(12) Patent Application Publication
(10) Pub. No.: US 2009/0014698 A1
(43) Pub. Date: Jan. 15, 2009

(54) E Z STRETCH

(76) Inventors: Jake Herrington, Del Rio, TX (US); Thomas Elerson, Waxahachie, TX (US)

Correspondence Address: WILSON DANIEL SWAYZE, JR., 3804 CLEARWATER CT., PLANO, TX, 75025, US

(21) Appl. No.: 11/776,900

(22) Filed: Jul. 12, 2007

(51) Int. Cl. B25B 25/00

(52) U.S. Cl. 254/199

(57) ABSTRACT

A fence pulling system for pulling a fence includes a male member, a female member to connect to the male member, a pivot member to allow the male member to pivot with respect to the female member, and a clamp member to allow the fence to clamped. The pivot member may include an aperture member, and the pivot member may include a L-shaped member. The male member may include the aperture member, and the female member may include the L-shaped member. The clamping member may include a male clamping member, and the clamping member may include a first female clamping member and a second female clamping member. The frame member may include a longitudinal frame member, and the frame member may include a traverse frame member.

### FIELD OF THE INVENTION

This invention relates generally to the construction of wire fences and more specifically to an improved clamp device for use in stretching fence wire between fence posts.

### BACKGROUND OF THE INVENTION

Non-rigid fencing material, such as woven or fabric steel fencing, must be pulled tightly across set-in fence-posts to which the material is to be attached, to prevent looseness and sagging that would be unsightly and detract from the structural integrity of the fence. A particular consideration is to pull top and bottom edges of the fencing material with substantially the same degree of tensile force, so that stress carried by the fabric of the fence is equally distributed thereacross. The problem is complicated by the need to apply the fencing material so that it substantially follows the contour of the ground over which it is being installed.

A particularly advantageous prior art fence clamp for pulling such fencing material is manufactured and marketed by Stewart Fence Co., LLC of Scappoose, Oreg., as the STEWART FENCE CLAMP STRETCHER (hereinafter the “Stewart” fence clamp). The Stewart fence clamp gains purchase on the fencing material across substantially the entire width of a free end thereof. The puller includes attachments proximate to the top and bottom corners of the free end for hooking respective lengths of upper and lower chain which are, in turn, hooked together at a pull-point carried by a pulling engine or device such as a tractor or come-along. Such chain connections between a fence-pulling device and a tractor are exemplified in, e.g., Combs, Jr., U.S. Pat. No. 3,881,690 and Handley, U.S. Pat. No. 3,211,426. Where the fencing material is to be attached to fence-posts set in level ground, and where the elevation of the pull-point is appropriately selected to lie midway between the respective points of attachment of the two chains, achievement of the aforementioned objective is naturally compelled by simple principles of geometry.

However, typically, the fencing material is to be attached to a course of vertical fence-posts that are set in ground that changes elevation. The fencing is stretched over such a number of the fence-posts that a taut length of fencing material will be above the ground level of the fence-posts that lie between a first and last fence-post. The fencing material is then manually pulled downwardly, at each fence-post, to register the fencing material with the fence-post for attachment thereto. Generally, however, the fencing material lies on a line making an angle with respect to the fence-posts, and the simplified geometry of the above described configuration is lost. Particularly, when the fencing material is pulled at an angle, one of the aforementioned chains will generally carry an increased tensile force while the other chain will tend to slacken.

The ordinary method employed in response to this problem includes installing a temporary anchoring brace beyond the last fence-post, attaching the fencing material to the anchoring brace while the tractor continues to carry the load of the partially taut fence, positioning the tractor to shift the load to the anchoring brace and thereby relieving the tension on the upper and lower chains, effectively shortening the slackened chain by hooking the chain to the pull-point through a different link of the chain, re-positioning the tractor to shift the load back thereto, releasing the fence from the temporary anchoring brace, and proceeding to pull the fencing material increasingly taut. A number of iterations of this time-consuming procedure may be required.

against lug elements projecting from a base plate in order to clamp the wire in place. Such devices have not enjoyed substantial acceptance or success, primarily because the cam members are unduly complex and costly. For example, the camming bar shown in the Combs U.S. Pat. No. 3,881,690 comprises essentially a round bar which has been cut longitudinally in half and welded back together with the halves offset somewhat to achieve a cam configuration. Manifestly, the difficulty involved in fabricating this type of camming bar leads to a high production cost.

Another type of wire stretcher is shown in the Handley U.S. Pat. No. 1,911,274 in which cylindrical clamping sections are arranged eccentrically on a bar in order to produce a camming effect when the bar is turned. Again, the fabrication cost is high due to the difficulty of forming the clamping sections eccentrically on the bar. In addition, since large spaces are presented between the clamping sections, the bar is able to slide axially on the base and thus possibly work loose as it is being used. Accordingly, the device is highly susceptible to slipping along the fence wire as the fence is being strung.

U.S. Pat. No. 4,046,353 discloses a device for stretching fence wire tightly between fence posts. A flat base plate has outwardly projecting L-shaped fingers which present end portions that are spaced from and parallel to the plate surface. A round camming bar is provided with partial circumferential grooves which are eccentric with respect to the bar axis. The fence wire is placed on the base plate, and the bar is placed on the wire with the grooves registering with the fingers. Turning of the bar causes camming action between the fingers and eccentric grooves in order to press the bar tightly against the base plate with the fence wire clamped tightly therebetween.

US Patent Application 20020175528 discloses a fence-pulling device and method for attaching non-rigid fencing material to fence-posts. One end of a sliding chain is connected to a fence-pulling engine such as a tractor, while the other end of the sliding chain is hookably attached to a slide bar adapted to permit the sliding chain to slide along portions thereof in response to components of the pulling force which are aligned with the slide bar, such as would result, for example, where fencing material is applied to fence-posts set in non-level.

### SUMMARY

A fence pulling system for pulling a fence includes a male member, a female member to connect to the male member, a pivot member to allow the male member to pivot with respect to the female member, and a clamp member to allow the fence to clamped.

The pivot member may include an aperture member, and the pivot member may include a L-shaped member.

The male member may include the aperture member, and the female member may include the L-shaped member.

The clamping member may include a male clamping member, and the clamping member may include a first female clamping member and a second female clamping member.

The frame member may include a longitudinal frame member, and the frame member may include a traverse frame member.

The frame member may include an inclined frame member.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a top view of the male and female member of the present invention;

FIG. 2 illustrates a side view of the male and female member of the present invention;

FIG. 3 illustrates a top view of the male and female member folded together;

FIG. 4 illustrates a section of the male and female member of the present invention.

### DETAILED DESCRIPTION

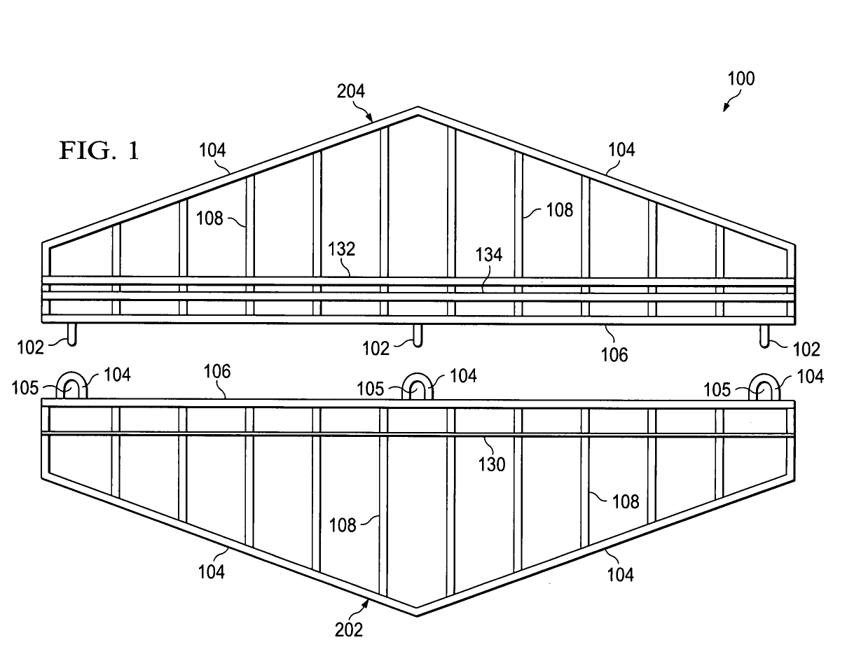

FIG. 1 illustrates the fence pulling system 100 of the present invention. The fence pulling system 100 includes a male member 202 and a female member 204 which is detachedly connected to the male member 202. The male member 202 and the female member 204 clamp a section of wire so that the wire can be pulled to a taunt condition and may be constructed from a rigid material such as steel or iron or other appropriate material. The male member 202 and the female member 204 include a frame member which is similar and includes a longitudinal frame member 106 which extends along the end of the male member 202 and the female member 204 in the longitudinal direction. Additionally, the male member 202 and the female member 204 include a traverse frame member 108 which is traverse to the longitudinal frame member 206 and which is of generally varying and increasing length from one end of the male member 202 and the female member 204 and reach a maximum length towards the center of the male member 202 and the female member 204. The traverse frame member 108 terminates in an inclined frame member 104 which extends from the end of the male member 202 and the female member 204 to the general center of the male member 202 and the female member 204.

FIG. 1 additionally illustrates that the female member 204 includes an L-shaped member 102 and that the male member 202 includes a aperture member 104 which cooperates with the L-shaped member 102 so that the male member 202 and the female member 204 can be easily detachedly connected and allow the male member of 202 and the female member 204 to pivot with respect to each other so that the fence can be clamped. The aperture member 104 includes aperture 105 generally in the center to accept the L-shaped member 102.

The female member 204 includes a first female clamping member 132 and a second female clamping member 134 which are in a spaced relationship with respect to each other and extend in the longitudinal direction of the female member 204. The first female clamping member 132 and the second female clamping member 134 may be parallel in order to maintain the same spaced relationship with respect to each other.

The male member 202 includes a male clamping member 130. The first female clamping member 132 and the second female clamping member 134 accept the male clamping member 130 so that when a fence section has been placed between the female clamping member 132, 134 and the male clamping member 130, the fence section can be clamped and held with little or no movement. This allows the fence to be pulled without it escaping the fence pulling system 100.

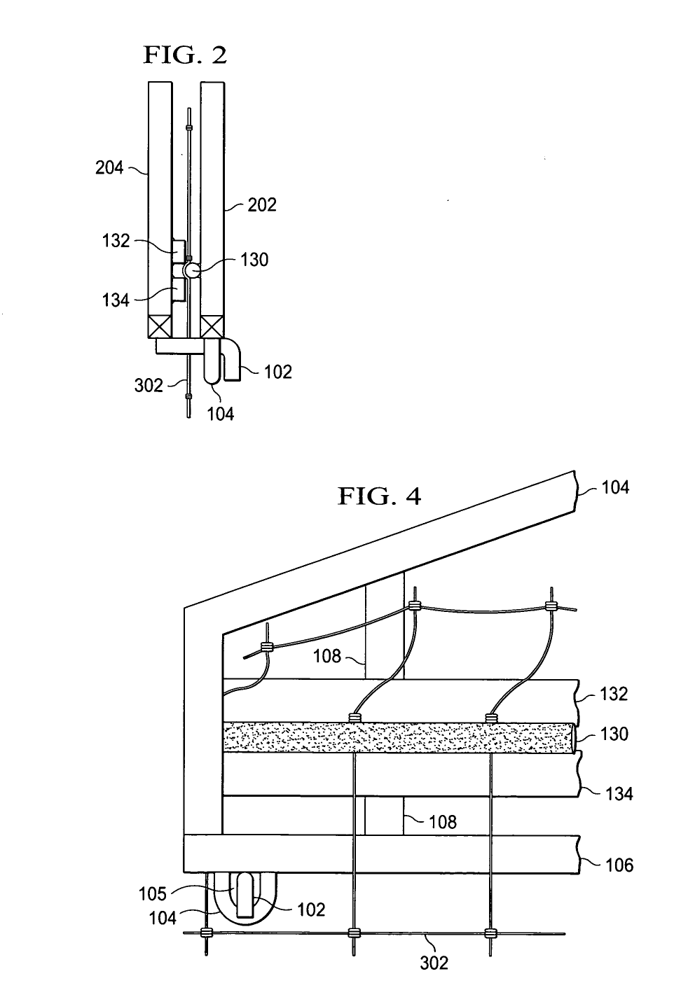

FIG. 2 illustrates the operation of the fence pulling system 100. The male member 202 has been positioned so that the aperture member 104 has been placed over the L-shaped member 102 of the female member 204 so that the male clamping member 130 engages the fence section 302 and forces the fan section 302 between the first clamping female member 130 and the second clamping female member 132. The fence section 302 may be deformed slightly so that it will not slip between the first clamping female member of 130, the second clamping female member of 132 and the male clamping member of 130.

FIG. 2 illustrates a side view of the male member 202, and FIG. 2 illustrates the aperture member 104 having an aperture 105 and the L-shaped member 102 of the female member 204. The male clamping member 130 is clamped between the first female clamping member 132 and the second female clamping member 134 to hold the wire section 302 in place while it is being pulled.

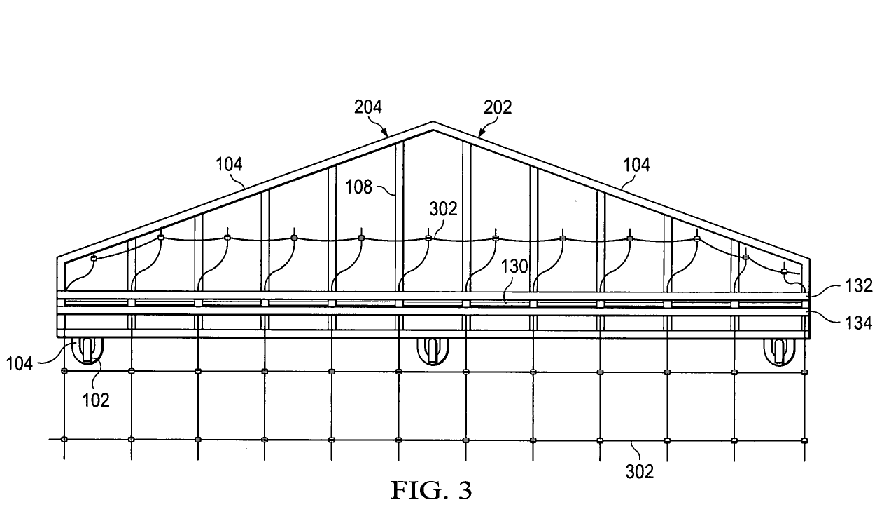

FIG. 3 illustrates a top view of the fence pulling system 100. FIG. 3 illustrates that the male member 202 and the female member 204 have been pivoted together to compress the fence section 302. FIG. 3 illustrates the L-shaped member 102 and the aperture member 104 to allow the male member 202 and the female member 204 to be detachedly connected. The male clamping member 130, the first female clamping member 132 and the second female clamping member 134 cooperating to compress the fence section 302.

FIG. 4 illustrates a portion of the fence pulling system 100. FIG. 4 illustrates the frame member including the longitudinal frame member 106, the inclined frame member 104 and the traverse frame member 108. The fence pulling system 100 includes a pivot member which includes the male member 202 and the female member 204 which are detachedly connected and pivot on the L-shaped member 102 and the aperture member 104. The fence section 302 is clamped by a clamping member which includes the male clamping member 130 on the first female clamping member 132 and the second female clamping member 134.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A fence pulling system for pulling a fence, comprising:
a male member;
a female member to connect to the male member;
a pivot member to allow the male member to pivot with respect to the female member;
a clamp member to allow the fence to clamped.

2) A fence pulling system for pulling a fence as in claim 1, wherein the pivot member includes a aperture member.

3) A fence pulling system for pulling a fence as in claim 2, wherein the pivot member includes a L-shaped member.

4) A fence pulling system for pulling a fence as in claim 3, wherein the male member includes the aperture member.

5) A fence pulling system for pulling a fence as in claim 3, wherein the female member includes the L-shaped member.

6) A fence pulling system for pulling a fence as in claim 1, wherein the clamping member includes a male clamping member.

7. A fence pulling system for pulling a fence as in claim 1, wherein the clamping member includes a first female clamping member.

8) A fence pulling system for pulling a fence as in claim 7, wherein the clamping member includes a second female clamping member.

9) A fence pulling system for pulling a fence as in claim 8, wherein the female member includes the first female clamping member.

10) A fence pulling system for pulling a fence as in claim 8, wherein the female member includes the second female clamping member.

11) A fence pulling system for pulling a fence as in claim 6, wherein the male member includes the male clamping member.

12) A fence pulling system for pulling a fence as in claim 1, wherein the frame member includes a longitudinal frame member.

13) A fence pulling system for pulling a fence as in claim 1, wherein the frame member includes a traverse frame member.

14) A fence pulling system for pulling a fence as in claim 1, wherein the frame member includes an inclined frame member.
